(19) United States
(12) Patent Application Publication
(10) Pub. No.: US 2019/0360824 A1
(43) Pub. Date: Nov. 28, 2019

(54) INFORMATION PROCESSING APPARATUS, INFORMATION PROCESSING METHOD, AND INFORMATION PROCESSING SYSTEM

(71) Applicant: TOYOTA JIDOSHA KABUSHIKI KAISHA, Toyota-shi (JP)

(72) Inventor: Seii SAI, Yokohama-shi (JP)

(73) Assignee: TOYOTA JIDOSHA KABUSHIKI KAISHA, Toyota-shi (JP)

(21) Appl. No.: 16/421,528

(22) Filed: May 24, 2019

(30) Foreign Application Priority Data
May 28, 2018 (JP) 2018-101448

(51) Int. Cl. G01C 21/34; G01C 21/30

(52) U.S. Cl. CPC G01C 21/3415; G01C 21/30; G01C 21/3423; G01C 21/343

(57) ABSTRACT

An information processing apparatus includes a controller. The controller is configured to: start guidance processing for a first route in response to a route guidance request, search for second routes as alternatives to the first route when it is determined that a user terminal that is a source of the route guidance request will be delayed from the first route, acquire a start time of a first schedule that is a purpose of a travel along the first route and a first location associated with the first schedule, determine whether or not arrival at the first location before the start time will be achieved through a travel along each of the second routes, and output information about each of the second routes and information about whether or not arrival at the first location before the start time will be achieved through a travel along each of the second routes.

### CROSS-REFERENCE TO RELATED APPLICATION

This application claims the benefit of Japanese Patent Application No. 2018-101448, filed on May 28, 2018, which is hereby incorporated by reference herein in its entirety.

### BACKGROUND

### Technical Field

The present disclosure relates to an information processing apparatus, an information processing method, and an information processing system.

### Description of the Related Art

A technique has been disclosed in which, for route guidance, route re-search is carried out according to the situation of passage of a predetermined point set on the route, and route guidance following the re-search is carried out.

### CITATION LIST

### Patent Document

Patent document 1: Japanese Patent Laid-Open No. 1995-282394

Patent document 2: Japanese Patent Laid-Open No. 2010-54390

Patent document 3: Japanese Patent Laid-Open No. 2017-3602

Unfortunately, although a schedule is often set at or around the route destination, route re-search in route guidance does not often consider an influence on the schedule set at or around the destination of a travel along the route.

An object of the present disclosure is to provide an information processing apparatus, an information processing method, and an information processing system that can suggest an influence of a re-searched route on a schedule set at or around the destination of a travel along the initial route.

### SUMMARY

One aspect of the present disclosure is an information processing apparatus including:

a controller configured to:

start guidance processing for a first route in response to a route guidance request,

search for one or more second route as alternative to the first route when it is determined that a user terminal that is a source of the route guidance request will be delayed from the first route,

acquire at least a start time of a first schedule that is a purpose of a travel along the first route and a first location associated with the first schedule,

determine whether or not arrival at the first location before the start time will be achieved through a travel along each of the one or more second routes, and

output information about each of the one or more second routes and information about whether or not arrival at the first location before the start time will be achieved through a travel along each of the one or more second routes.

According to the present disclosure, an influence of a re-searched route on a schedule set at or around the destination of a travel along the initial route can be suggested.

### BRIEF DESCRIPTION OF DRAWINGS

FIG. 1 is a diagram illustrating one example of the configuration of a multimodal transport service providing system according to the first embodiment;

FIG. 2 is a diagram illustrating an example of the hardware configuration of the server;

FIG. 3 is a diagram illustrating an example of the functional configuration of the server;

FIG. 4 is a diagram illustrating an example of the hardware configuration of the user terminal;

FIG. 5 is a diagram illustrating an example of the functional configuration of the user terminal;

FIGS. 6A and 6B illustrate one example of a flow chart of processing in the route generation unit of the server;

FIG. 7 is a diagram illustrating an example of rerouting determination processing;

FIG. 8 is one example of a flow chart of rerouting determination processing in the route generation unit of the server;

FIG. 9 is one example of a flow chart of rerouting suggestion processing in the route generation unit of the server;

FIG. 10 is a diagram illustrating an example of search conditions input screen of the user terminal;

FIG. 11 is one example of search result output screen on the user terminal;

FIG. 12 is one example of rerouting inquiry screen on the user terminal;

FIG. 13 is one example of rerouting information suggesting screen on the user terminal;

FIG. 14 is one example of rerouting guidance start screen on the user terminal;

FIG. 15 is one example of a flow chart of schedule identifying processing in the user terminal.

### DESCRIPTION OF THE EMBODIMENT

Hereinafter, an embodiment of the present disclosure will be described with reference to the drawings. The configuration of the following embodiment is merely an example, and the present disclosure is not limited to the configuration of the embodiment.

One aspect of the present disclosure is an information processing apparatus including a controller. The controller is configured to start guidance processing for a first route in response to a route guidance request, and search for one or more second routes as alternatives to the first route when it is determined that a user terminal that is a source of the route guidance request will be delayed from the first route. Further, the controller is configured to acquire at least a start time of a first schedule that is a purpose of a travel along the first route and a first location associated with the first schedule. Furthermore, the controller is configured to determine whether or not arrival at the first location before the start time of the first schedule will be achieved through a travel along each of the one or more second routes. The controller is configured to output information about each of the one or more second routes and information about whether or not arrival at the first location before the start time of the first schedule will be achieved through a travel along each of the one or more second routes.

Examples of the fact that the user terminal is delayed from the first route include the fact that the user terminal will not arrive at a via point included in the first route before an estimated arrival time, and the fact that the service or driving of a transportation included in the first route is delayed. Note that in this description, examples of type of transportation include railway, bus, airplane, taxi, ferry, car rental, and bike rental. Examples of the fact that the driving of the transportation is delayed include road traffic jam. Examples of output of the controller include transmission to a predetermined device. Note that acquisition of the start time and the first location of the first schedule may be performed before or after the second route search.

According to one aspect of the present disclosure, whether or not the user will arrive at the first location before the start time of the first schedule that is the purpose of a travel along the first route, through a travel along each of the second routes as alternatives to the first route during guidance processing is suggested, so that the user of the user terminal can recognize an influence of each of the second routes on the first schedule.

In addition, in one aspect of the present disclosure, when determining that arrival at the first location before the start time of the first schedule will not be achieved through a travel along the second route, the controller may calculate a time length delayed from the start time. Further, in this case, the controller may output the time length delayed from the start time together with information about the second route. Accordingly, the user of the user terminal can recognize how long he/she will be late through a travel along the second route and, for example, in the case where multiple second routes exist, can select a route to be used, based on these information pieces.

In addition, in one aspect of the present disclosure, the controller may be configured to: further acquire information about an address of a participant of the first schedule, and when the controller determines that arrival at the first location before the start time of the first schedule will not be achieved through a travel along a route selected as a guidance target among the second routes, send the notification that the user of the user terminal will be late, to the address of the participant. Accordingly, an influence of a travel along the second route on the first schedule can also be informed to the participant of the first schedule. Accordingly, the user of the user terminal does not need to perform an operation for sending the notification that he/she will be late, so that work of the user of the user terminal can be saved.

In addition, in one aspect of the present disclosure, the controller may be configured to: acquire information about a schedule set in the user terminal, extract a noun related to a location from the acquired information about the schedule, acquire location information corresponding to the extracted noun, and identify the first schedule based on a comparison between location information about the user terminal and the location information corresponding to the extracted noun. Accordingly, even in the case where the first schedule that is the purpose of a travel along the first route is not identified in advance, the first schedule can be identified even without an operation or the like by the user of the user terminal.

Another aspect of the present disclosure is an information processing method including: starting guidance processing for a first route in response to a route guidance request; searching one or more second routes as alternatives to the first route when it is determined that a user terminal that is a source of the route guidance request will be delayed from the first route; acquiring at least a start time of a first schedule that is a purpose of a travel along the first route and a first location associated with the first schedule; determining whether or not arrival at the first location before the start time will be achieved through a travel along each of the one or more second routes; and outputting information about each of the one or more second routes and information about whether or not arrival at the first location before the start time will be achieved through a travel along each of the one or more second routes.

Another aspect of the present disclosure is an information processing system including one or more controllers. The one or more controllers are configured to: start guidance processing for a first route in response to a route guidance request, search for one or more second routes as alternatives to the first route when it is determined that a user terminal that is a source of the route guidance request will be delayed from the first route, acquire at least a start time of a first schedule that is a purpose of a travel along the first route and a first location associated with the first schedule, and determine whether or not arrival at the first location before the start time will be achieved through a travel along each of the one or more second routes. The controller is configured to output information about each of the one or more second routes and information about whether or not arrival at the first location before the start time will be achieved through a travel along each of the one or more second routes. The one or more controllers may be devices independent of each other.

Note that technical ideas disclosed in relation to the above-described information processing apparatus are applicable to the information processing method and the information processing system as long as technical inconsistency does not occur.

### First Embodiment

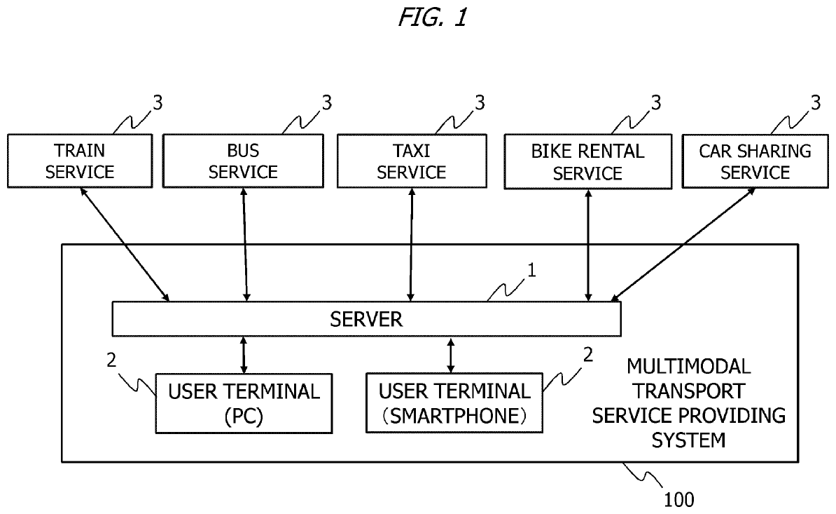

FIG. 1 is a diagram illustrating one example of the configuration of a multimodal transport service providing system 100 according to the first embodiment. The multimodal transport service providing system 100 is a system that provides a service that can route multiple types of transportations, such as train, bus, airplane, ferry, taxi, rent-a-car, car sharing, and bike rental, at once for route search.

The multimodal transport service providing system 100 includes a server 1 and multiple user terminals 2. A user terminal 2 is a smartphone or tablet terminal, for example. Alternatively, a user terminal 2 may be a portable personal computer (PC). In addition, a user terminal 2 is installed with an application related to a service provided by the multimodal transport service providing system 100 and owned by a user who is user-registered to the service. Note that FIG. 1 illustrates one PC and one smartphone representing user terminals 2. The user terminals 2 access to the server 1 via the Internet or other networks through web communication.

The server 1 is connected to, for example, systems 3 of the service providers of transportations, such as train, bus, taxi, bicycle-sharing system, and car sharing, via a network, using an application programming interface (API). The server 1 allows the systems 3 of the service providers of the transportations to, for example, check statuses of usage, check seat availabilities, and make reservations. The server 1 according to the first embodiment is one example of “information processing apparatus”.

Examples of the services provided by the systems 3 of the service providers of the transportations include a service for providing information about each transportation and a reservation service for accepting reservations for transportations set with reservation reception. Information about each transportation include, for example, timetables, route maps, fees, and seat availabilities.

In the first embodiment, the server 1 performs route search according to a route search request from a user terminal 2, using information held in the systems 3 of the service providers of the transportations, creates multiple routes, and transmits them to the user terminal 2. On the user terminal 2, the routes as the search results are displayed. If the user of the user terminal 2 selects a route to be adopted, information about the selected route is transmitted from the user terminal 2 to the server 1. A route selected by the user of the user terminal 2 from the routes as the search results is hereinafter referred to as a selected route. The selected route is stored in the server 1.

The server 1 starts guidance processing about selected route when, for example, receiving information about the selected route together with a reservation of route guidance, or receiving a route guidance request from the user terminal 2. A target route of route guidance is hereinafter referred to as a guided route. A user terminal 2 is one example of “user terminal that is the source of a route guidance request”. A guided route is one example of “first route”. A route guidance request is one example of “route guidance request”.

For example, in the route guidance processing in the server 1, as the user terminal 2 approaches a predetermined transfer point set in the guided route, the event at the transfer point is notified to the user terminal 2 and route guidance is provided to the user of the user terminal 2. For example, multiple transfer points in the guided route are set at right turn or left turn points, transfer stations, and the like. Examples of events at transfer points include changes in travel direction, such as right turns and left turns, and changes in transportation, such as train transfers. Route guidance processing is one example of “guidance processing for a route”.

For example, during route guidance, the user terminal 2 transmits a set of location information and time information to the server 1 in a predetermined period. In addition, the server 1 calculates an estimated arrival time for each transfer point in the guided route. During processing of route guidance, in a predetermined period, the server 1 compares the location information and time information related to the user terminal 2 with the location information and estimated arrival time related a transfer point set in the guided route, and monitors whether the user terminal 2 is delayed from the guided route.

When detecting a delay of the user terminal 2 from the guided route, the server 1 searches for an alternative route. Search for an alternative route performed in the case where the user terminal 2 is delayed from the guided route is hereinafter referred to as rerouting. Rerouting is one example of “search for a second route as an alternative to a first route”. A route obtained by rerouting is one example of “second route”.

A travel often accompanies a purpose. Examples include a travel to a meeting location with a friend, a travel to an appointment location, or the like. In other words, a location associated with a schedule often exists at or around the route destination. To determine an influence of a travel along each route obtained by rerouting on a schedule set at or around the destination of the guided route, the server 1 obtains information about the schedules from the user terminal 2.

Information about schedules is, for example, start times, locations, participant's addresses, and other information, or the like. The server 1 identifies a schedule corresponding to the purpose of the travel along the guided route, and determines whether the user will arrive the location of the schedule before the start time of the schedule through the route obtained by rerouting, how long the user will be late, or the like. The server 1 transmits, along with information about the route obtained by rerouting, information about whether the user will arrive before the start time of the schedule, a delay time, or other information for each route, to the user terminal 2. A schedule corresponding to the purpose of a travel along a guided route is one example of “first schedule”. A location included in schedule information is one example of “a first location associated with a first schedule”.

The user of the user terminal 2 on which information about the route obtained by rerouting is displayed along with information about whether the user will arrive before the start time of the schedule, a delay time, or other information for each route, can recognize influences of a travel along the route obtained by rerouting upon a schedule.

In addition, in the first embodiment, in the case where the user will not arrive before the start time of a schedule through a travel along a route selected by the user of the user terminal 2 among the routes obtained by rerouting, the server 1 notifies the fact that the user will be late and/or the delay time to the participant's addresses included in information about the schedule. Participant's address is, for example, E-mail address, the account name on social networking services (SNSs), or the like. Hence, when the user of the user terminal 2 is late for the schedule, the notification about the delay is automatically sent to participants, so that the participants of the schedule can be easily informed of the user's conditions. Although the server 1 is explained as being a single server in the first embodiment, the server 1 may be implemented by multiple computers connected to a cloud.

<Device Configuration>

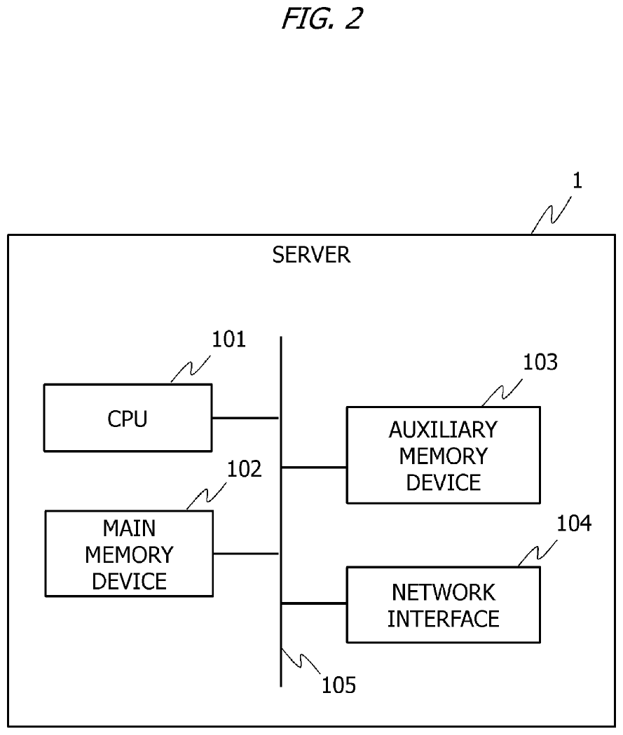

FIG. 2 is a diagram illustrating an example of the hardware configuration of the server 1. The server 1 includes, as hardware components, a CPU 101, a main memory device 102, an auxiliary memory device 103, and a network interface 104. These hardware components are electrically connected through, for example, a bus 105.

The CPU 101 executes a computer program expanded to be executable in the main memory device 102 and executes processing as the server 1. The main memory device 102 stores the computer program executed by the CPU 101, data processed by the CPU 101, and the like. The main memory device 102 is, for example, a dynamic random access memory (DRAM), a static random access memory (SRAM), or a read only memory (ROM). The auxiliary memory device 103 is a nonvolatile memory device, for example, hard disc drive, solid state drive (SSD), or the like.

The network interface 104 connects to, for example, a public communication network via a LAN, and communicates with the systems 3 of the service providers of the transportations, the user terminals 2, and the like on the network via the public communication network.

In FIG. 2, the server 1 includes a single CPU 101. Note that the CPU is not limited to a single processor but may have a multiprocessor configuration. Alternatively, a single CPU connected via a single socket may have a multicore configuration. At least part of the above-described processing of the units may be performed in a processor other than a CPU, for example, a digital signal processor (DSP), a graphics processing unit (GPU), or other dedicated processors. Moreover, at least part of the above-described processing in the units may be an integrated circuit (IC) or other digital circuits. At least part of the units may include an analog circuit.

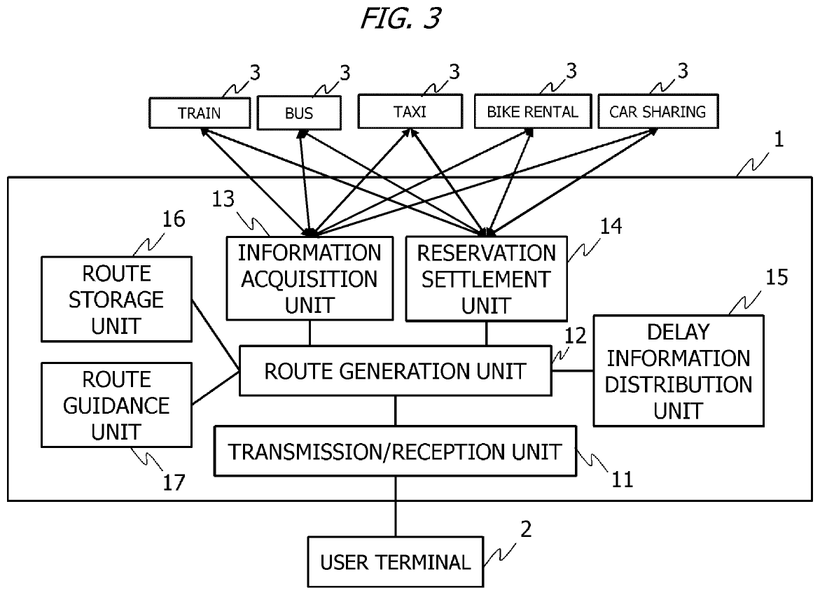

FIG. 3 is a diagram illustrating an example of the functional configuration of the server 1. The server 1 operates on a computer program in the main memory device 102, as the units illustrated in FIG. 3. In other words, the server 1 includes, as functional components, a transmission/reception unit 11, a route generation unit 12, an information acquisition unit 13, a reservation settlement unit 14, a delay information distribution unit 15, a route storage unit 16, and a route guidance unit 17.

The transmission/reception unit 11 is an interface to user terminals 2. For example, the transmission/reception unit 11 receives, from a user terminal 2, a set of location information and information about the time at which the location information is acquired, route search requests, route guidance requests, information about the selected route, and the like. The transmission/reception unit 11 transmits, for example, information about multiple routes as search results to the user terminal 2. The transmission/reception unit 11 outputs, for example, data from the user terminal 2 to the route generation unit 12.

The route generation unit 12 receives, from the transmission/reception unit 11, a route search request from the user terminal 2. Together with the route search request from the user terminal 2, search conditions including a departure place and destination, a departure date and time or arrival date and time, a via point desired to be passed through, and a transportation desired to be used, which are designated by the user of the user terminal 2, for example, are received. The search conditions may include, for example, information about a via point, transportation, or the like which is an exclusion target.

The route generation unit 12 extracts the system 3 of the service provider of an available transportation, based on the departure place and destination included in the search conditions. The extracted system 3 is, for example, the system 3 of the service provider of a transportation covering part or all of the area between the departure place and the destination, the transportation being designated as a search target in search conditions or not being designated as an exclusion target, or the like.

The route generation unit 12 instructs the information acquisition unit 13 to acquire information from the extracted system 3. Information acquired from the system 3 of the service provider of the transportation is, for example, railway route timetables, seat availabilities, reservation conditions, fee information provided by the system 3, or the like.

The route generation unit 12 receives, from the information acquisition unit 13, an input of information acquired from the system 3 of the service provider of the transportation and creates, based on the information, multiple routes satisfying the search conditions. The method of creating the routes is not limited to a particular one and any known technique can be used.

The route generation unit 12 transmits information about the created multiple routes to the user terminal 2 that is the source of the route search request, through the transmission/reception unit 11. Information about the routes transmitted to the user terminal 2 include, for example, the transportations used between the departure place and a via point, between via points, and between the final via point and the destination, and the departure times and arrival times at the departure place, the destination, and each via point.

The route generation unit 12 receives information about the selected route input from the user terminal 2 through the transmission/reception unit 11. The route generation unit 12 outputs information about the selected route to the route storage unit 16 which then stores it. Together with information about the selected route, the search conditions for the selected route are stored. In addition, when receiving schedule information related to a schedule which is the purpose of the travel along the selected route from the user terminal 2, together with information about the selected route, the schedule information is also stored being associated with information about the selected route. Schedule information contains a start day and time, a location, and the like. Schedule information also contains an end time, participants, participant's addresses, and the like in some cases.

Note that schedule information from the user terminal 2 is received, for example, when, in the user terminal 2, schedule information managed by a schedule management application is specified and a route search request is generated using the specified schedule information.

Moreover, together with information about the selected route, a request for reserving route guidance for the selected route is received from the user terminal 2 in some cases. When, together with information about the selected route, a request for reserving route guidance for the selected route is received from the user terminal 2, the route generation unit 12 sets a timer for the start time of the selected route.

For example, when the timer set for the start time of the selected route expires or when a route guidance request is received from the user terminal 2, the route generation unit 12 instructs the route guidance unit 17 to start route guidance. When receiving a route guidance request from the user terminal 2, information about the guidance target route is received together with the route guidance request.

The route generation unit 12 performs rerouting determination processing during execution of route guidance processing in the route guidance unit 17. The rerouting determination processing is processing for determining whether or not rerouting conditions are satisfied. Rerouting conditions are conditions under which rerouting is performed. Examples of rerouting conditions include the situation where the user goes out of a guided route, the situation where a delay occurs in a public transport included in a guided route, or the like. The details of rerouting determination processing will be described later. Satisfaction of rerouting conditions is one example of “detection of a delay of a user terminal that is the source of a route guidance request, from the first route”.

When the rerouting determination processing determines that the rerouting conditions are satisfied, the route generation unit 12 performs rerouting suggestion processing. Rerouting suggestion processing is processing for acquiring information related to a route that is an alternative to the guided route, provided to the user of the user terminal 2. To be specific, rerouting suggestion processing involves (A) identification of a destination, (B) search for a route that is an alternative to a guided route (rerouting), (C) identification of a schedule that is the purpose of a travel along the guided route, (D) determination of whether the user will be in time for the identified schedule through a travel along the route obtained by rerouting, and the like.

In (A) identification of a destination, the route generation unit 12 identifies the destination of rerouting. Note that the departure place of rerouting is the current position of a user terminal 2. The destination of rerouting may be, for example, the destination of the guided route as it is, or the location of a schedule that is the purpose of the travel along the guided route. In the first embodiment, the destination of rerouting is assumed to be the location of a schedule that is the purpose of the travel along the guided route.

In (B) search for a route that is an alternative to a guided route, the route generation unit 12 performs route search in the same manner as in normal route search. At this time, the departure place is the current position of the user terminal 2, the destination is the destination identified in (A) identification of the destination, the search conditions are search conditions obtained when the guided route stored in the route storage unit 16 is created.

In (C) identification of a schedule that is the purpose of a travel along the guided route, for example, when schedule information associated with the guided route is stored in the route storage unit 16, the route generation unit 12 acquires the schedule from the schedule information. When no schedule information associated with the guided route is stored in the route storage unit 16, the route generation unit 12 makes an inquiry of the user terminal 2 to acquire multiple schedule information pieces, and identifies a schedule that is the purpose of a travel along the guided route, among the acquired multiple schedule information pieces.

The method of identifying a schedule that is the purpose of a travel along the guided route among multiple schedule information pieces is not limited to a particular method. For example, there is a method in which a point of interest (POI) is extracted from schedule information acquired from the user terminal 2, the location information about each POI is acquired, and identification is made by comparison with the location information about the user terminal 2. The method of identifying a schedule that is the purpose of a travel along the guided route among multiple schedule information pieces will be described in detail later.

In (D) determination of whether the user will be in time for the identified schedule through a travel along the route obtained by rerouting, the route generation unit 12 compares the start time of the schedule identified in (C) identification of a schedule that is the purpose of a travel along the guided route with the arrival time with the route obtained by rerouting. In the case where the arrival time with the route obtained by rerouting is after the start time of the identified schedule, the route generation unit 12 determines the time length of the difference. The determined time length of the difference is a delay time length indicating, when a delay for a schedule occurs, how long the user will be late for the schedule.

The route generation unit 12 transmits information about the route obtained by rerouting, information about whether the user will be in time for the schedule for each route, and, when a delay occurs, a delay time length to the user terminal 2.

The route generation unit 12 receives information about a selected route newly selected from the routes obtained by rerouting, from the user terminal 2 through the transmission/reception unit 11. Regarding the route generation unit 12, in the case where the user will be late through a travel along the newly selected route and the participant's addresses are set in schedule information corresponding to the schedule, the route generation unit 12 generates delay information. Delay information includes, for example, the user name of the user of the user terminal 2, information about the schedule, the fact that the user will be late for the schedule, and a delay time length indicating how long the user will be late.

The route generation unit 12 outputs an instruction to give an announce about the delay, to the delay information distribution unit 15. The route generation unit 12 outputs, together with an instruction to give an announce about the delay, the participant's address included in delay information and schedule information to the delay information distribution unit 15. The details of the route generation unit 12 will be described later.

The information acquisition unit 13 acquires information from the system 3 of the designated service provider according to the instruction from the route generation unit 12, and outputs the acquired information to the route generation unit 12.

The reservation settlement unit 14 makes a reservation of, for example, a designated train, flight, car, bicycle, or the like on the system 3 of the service provider of the designated transportation, according to the instruction from the route generation unit 12. When payment is involved in making the reservation, the reservation settlement unit 14 also performs payment. Payment information used for payment is acquired, for example, from a user information DB (not illustrated in the drawing) that retains information about the user.

The delay information distribution unit 15 receives an input of the instruction to give the announcement about the delay from the route generation unit 12. Together with the instruction to give the announcement about the delay, delay information and information about the address corresponding to the destination of the announcement are input. The delay information distribution unit 15 transmits the delay information to the designated address through the transmission/reception unit 11. Note that the delay information distribution unit 15 transmits it through the delay information in the mode dependent on the type of the designated address.

For example, when the address is an E-mail address, the delay information distribution unit 15 creates an E-mail including delay information and transmits it to an external E-mail server through the transmission/reception unit 11 and an API. The E-mail is transmitted from the E-mail server to the address. For example, when the address is an SNS account, the delay information distribution unit 15 creates an SNS message including delay information and transmits it to an external SNS server through the transmission/reception unit 11 and an API. The SNS message is transmitted from the SNS server to the address. Note that the source of the notification about the delay information is, for example, the server 1 or the multimodal transport service providing system 100 even if it is done through an E-mail or SNS message.

According to a request from the route generation unit 12 for data writing or reading, the route storage unit 16 writes or reads data to/from, for example, a predetermined storage area in the auxiliary memory device 103 of the server 1. Data for which a request for writing or reading is received at the route storage unit 16 from the route generation unit 12 includes, for example, for each user, information about the selected route, the routes in the guide history, or the like. Information about the routes includes information about the departure place, destination and via points related to the route, the departure time and arrival time, the arrival time and the departure time or passing time at each via point, and search conditions. Information about the route includes schedule information corresponding to the purpose of the travel along the route in some cases.

The route guidance unit 17 performs route guidance processing according to the instruction from the route generation unit 12. From the route generation unit 12, together with the instruction to start route guidance processing, information about the guided route is also input. While the route guidance unit 17 performs route guidance processing for the user terminal 2, when location information from the user terminal 2 is received, the location information about the user terminal 2 is input to the route guidance unit 17 through the transmission/reception unit 11 and the route generation unit 12.

In route guidance processing, for example, the route guidance unit 17 repeats comparison between the location information about a transfer point in the guided route and the location information about the user terminal 2 in a predetermined period. A transfer point is a point in the route at which a predetermined event involving a notification as a guidance for the user occurs. Concrete examples of the predetermined event include changes in travel direction, such as right turns and left turns, changes in transportation, such as train transfers, or the like.

When, for example, detecting the user terminal 2 entering to a predetermined range from the transfer point, the route guidance unit 17 notifies the user terminal 2 of the event at transfer point through the route generation unit 12 and the transmission/reception unit 11. The route guidance unit 17 terminates the route guidance processing, for example, when a guidance end notification from the user terminal 2 through the transmission/reception unit 11 and the route generation unit 12 is received or when arrival at the destination is detected.

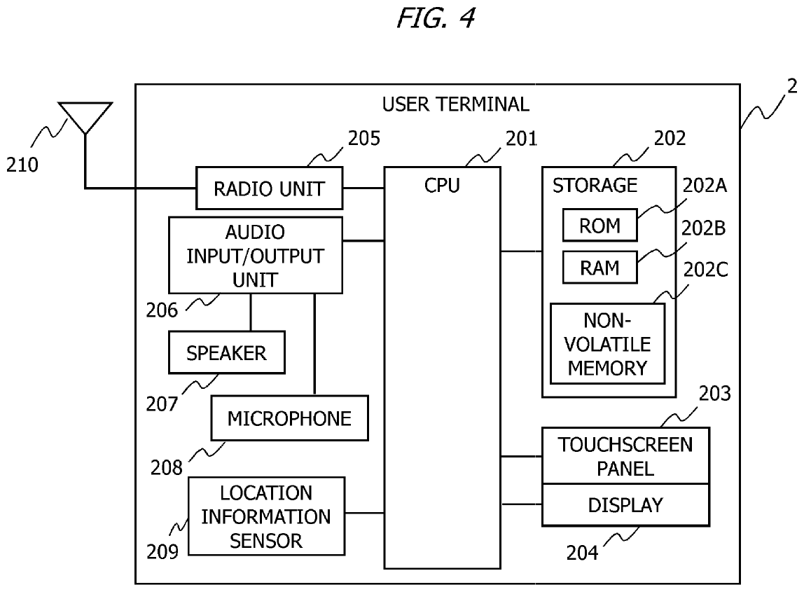

FIG. 4 is a diagram illustrating an example of the hardware configuration of the user terminal 2. The user terminal 2 is a smartphone, tablet terminal, or a portable PC, for example. The user terminal 2 includes a central processing unit (CPU) 201, a storage 202, a touchscreen panel 203, a display 204, a radio unit 205, an audio input/output unit 206, a speaker 207, a microphone 208, a location information sensor 209, and an antenna 210.

The storage 202 includes a read only memory (ROM) 202A, a random access memory (RAM) 202B, and a nonvolatile memory 202C. The RAM 202B is a volatile memory providing a work area to the CPU 201. The ROM 202A is a nonvolatile memory in which an OS, preinstalled applications, system data, and a like are stored. The nonvolatile memory 202C is, for example, a flash memory.

The nonvolatile memory 202C stores a multimodal traffic search application program, a schedule management application program, and other application programs, and the like. The multimodal traffic search application program is a program for receiving a service provided by the multimodal transport service providing system 100. The multimodal traffic search application program is acquired, for example, by being downloaded from a predetermined website on the Internet.

The touchscreen panel 203, which is a type of position input devices, is disposed over the surface of the display 204 and the coordinates of the corresponding position of a finger in touch to the screen of the display 204 are inputted on the panel 203. The touchscreen panel 203 may be of any of the following technologies: the electrostatic capacitance technology, the resistive film technology, the surface acoustic wave technology, the infrared technology, and the electromagnetic induction technology. The display 204 is, for example, a liquid crystal display (LCD). The display 204 displays screen data according to signals input from the CPU 201.

The radio unit 205, which is connected to the antenna 210, converts radio signals received through the antenna 210 to electrical signals to output them to the CPU 201, and converts electrical signals input from the CPU 201 to radio signals to transmit them through the antenna 210. The radio unit 205 is an electronic circuit based on, for example, any one or more of the following systems: WiFi (Wireless Fidelity), the third generation mobile telecommunications system, the fourth generation mobile telecommunications system (Long Term Evolution (LTE)), or the mobile telecommunications systems later than the fourth generation.

The audio input/output unit 206 is connected to a speaker 207 serving as an audio output device, and a microphone 208 serving as an audio input device. The audio input/output unit 206 converts audio signals input from the microphone 208 to electrical signals to output them to the CPU 201, and converts electrical signals input from the CPU 201 to audio signals to output them to the speaker 207.

The location information sensor 209 acquires location information about the user terminal 2 in a predetermined period. The location information sensor 209 is, for example, a global positioning system (GPS) receiving unit or a WiFi communication unit.

The CPU 201 expands programs stored in the ROM 202A or nonvolatile memory 202C into the RAM 202B, and executes the expanded commands, thereby performing various types of processing. One or more CPUs 201 may be provided.

Note that the hardware configuration of the user terminal 2 is not limited that illustrated in FIG. 4, and an appropriate variation, such as an addition, a replacement, and a deletion, can be made for it. For example, the user terminal 2 may include, in addition to the components illustrated in FIG. 4, a transportable recording medium driving device used to drive a transportable recording medium. The transportable recording medium is, for example, an SD card, micro SD card, or the like. In addition, the processor included in the user terminal 2 is not necessarily a single CPU 201, and multiple processors may be included instead. For example, the user terminal 2 may include a graphics processing unit (GPU) in addition to the CPU 201.

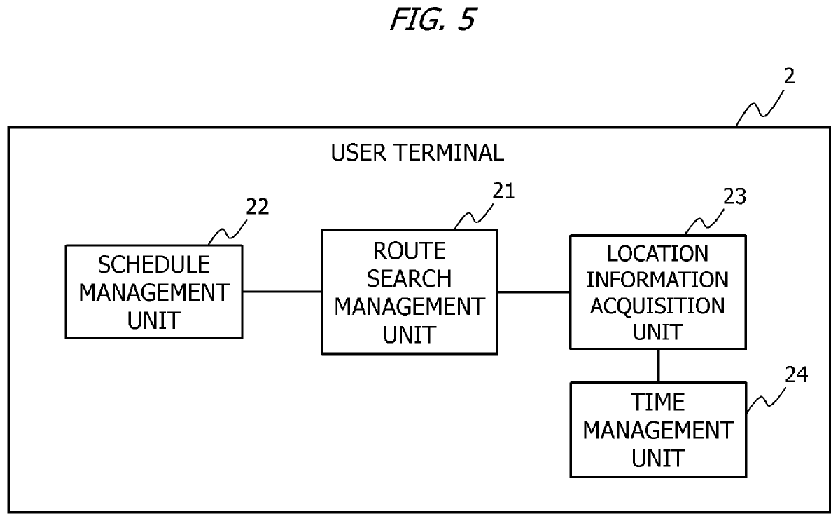

FIG. 5 is a diagram illustrating an example of the functional configuration of the user terminal 2. The user terminal 2 includes, for example, a route search management unit 21, a schedule management unit 22, a location information acquisition unit 23, and a time management unit 24 as functional components.

The route search management unit 21 is, for example, a functional component implemented when the CPU 201 executes a multimodal traffic application program. The route search management unit 21 receives inputs of route search conditions, route search requests, selection of a selected route, route guidance requests, and the like from the user through the touchscreen panel 203. In addition, the route search management unit 21 receives route search results, a notification about a predetermined event in route guidance, requests for acquisition of schedule information, and the like from the server 1.

For example, when a route search request from the user through the touchscreen panel 203 is input, the route search management unit 21 transmits the route search request to the server 1. The route search management unit 21 transmits, together with the route search request, for example, a departure place, a destination, search conditions, and the like input through a search conditions input screen, which will be described later, to the server 1. Note that, for example, when the route search management unit 21 is invoked by the schedule management unit 22 and the route search request for predetermined schedule information is input from the schedule management unit 22, the schedule information is also transmitted to the server 1 together with the route search request. To be specific, for example, a screen for the schedule management application program contains schedule information and a route search button, and selecting the route search button inputs a route search request for a route in which the destination is the location related to the schedule information.

For example, when multiple route information pieces as the results of route search are input from the server 1, the route search management unit 21 generates a search result output screen, which will be described later, containing the input multiple route information pieces, and outputs it to the display 204.

For example, when the user inputs, through the touchscreen panel 203, an operation for selecting a selected route among the multiple route information pieces as the results of route search, the route search management unit 21 transmits information about the selected route to the server 1. In addition, for example, in the case where the user is allowed to register route information as one piece of schedule information in advance, when the user inputs an operation for registering the selected route to a calendar through the touchscreen panel 203, the route search management unit 21 outputs an instruction to register the selected route to the schedule management unit 22, and the schedule management unit 22 registers the selected route to a schedule.

For example, when a route guidance request from the user through the touchscreen panel 203 is received, the route search management unit 21 transmits a route guidance request to the server 1. The route search management unit 21 transmits, together with the route guidance request, information about a route that is a guidance target to the server 1.

For example, when a request for acquisition of schedule information from the server 1 is received, the route search management unit 21 acquires schedule information from the schedule management unit 22. Access to the schedule management unit 22 is made, for example, through an API. Note that the route search management unit 21 may extract and acquire schedule information in which the start time is at or after the current date and time, for example, from the schedule management unit 22.

For example, when the end of the route guidance from the user through the touchscreen panel 203 is input, the route search management unit 21 transmits a notification about the end of the route guidance to the server 1.

The route search management unit 21 acquires location information about the user terminal 2 from the location information acquisition unit 23, for example, in a predetermined period. From the location information acquisition unit 23, together with location information, time information indicating the time at which the location information has been acquired is acquired. When a set of location information and time information is acquired, the route search management unit 21 transmits the set of location information and time information to the server 1. Note that the set of location information and time information may be transmitted, for example, continuously during the actuation of the multimodal traffic search application program or started in response to an input of a route guidance request.

The schedule management unit 22 is, for example, a functional component implemented when the CPU 201 executes a schedule management application program. The schedule management unit 22 manages, for example, schedule information. Schedule information is input by the user and stored in a predetermined storage area in the nonvolatile memory 202C. The schedule management unit 22 reads schedule information from the auxiliary memory device 103 in response to a request for acquisition from, for example, the route search management unit 21, and outputs it to the route search management unit 21. Note that the schedule management application program may be, for example, uniquely provided by the multimodal transport service providing system 100 or provided by other companies, organizations, or the like.

The location information acquisition unit 23 and the time management unit 24 are functional components implemented by, for example, execution of the OS by the CPU 201. The location information acquisition unit 23 acquires, for example, location information about the user terminal 2, which is acquired by the location information sensor 209, in a predetermined period. The location information about the user terminal 2 may be, for example, a latitude, a longitude, an address, or the like.

In addition, the location information acquisition unit 23 acquires, from the time management unit 24, the current time as the time at which the location information has been acquired, when acquiring the location information. The location information acquisition unit 23 overwrites the set of location information and time information and saves it to a predetermined storage area of the RAM 202B, and reads it, for example, in response to a request from the route search management unit 21.

The time management unit 24 manages time based on, for example, a clock (not illustrated in the drawing) mounted on the user terminal 2. The time management unit 24 acquires a time, for example, in response to a request from the location information acquisition unit 23 and outputs it to the location information acquisition unit 23.

<Processing Flow>

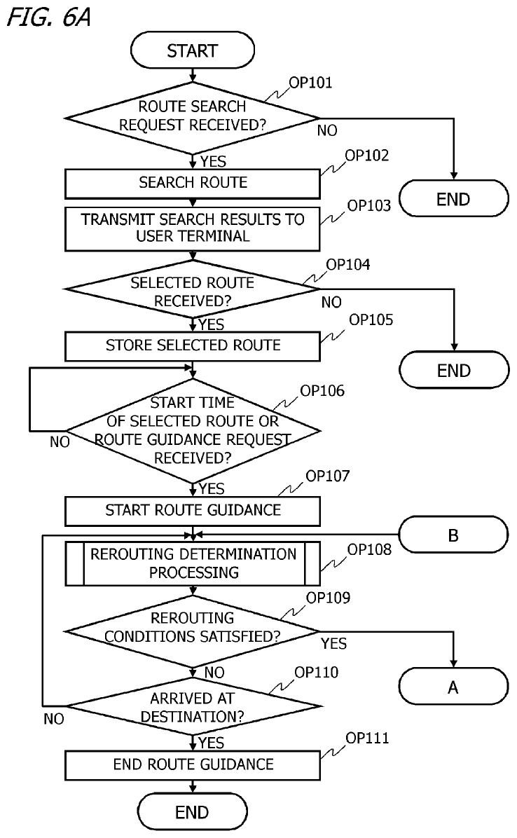

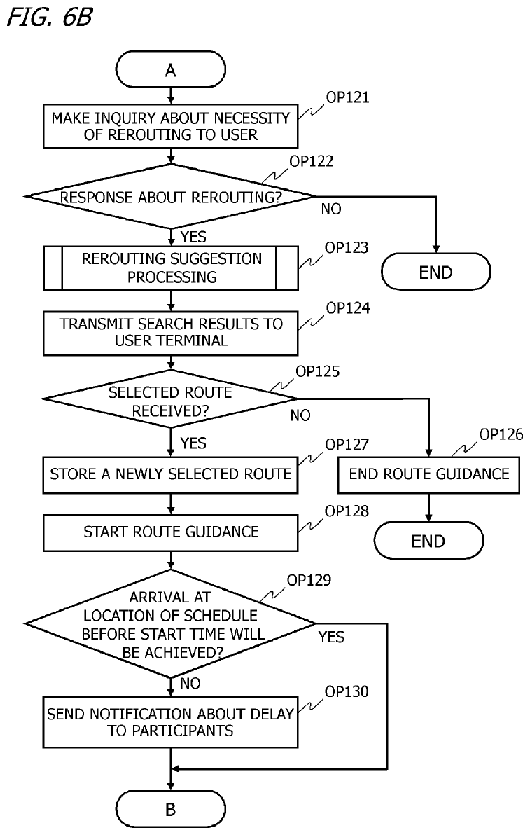

FIGS. 6A and 6B illustrate one example of a flow chart of processing in the route generation unit 12 of the server 1. The processing illustrated in FIGS. 6A and 6B is, for example, repeated in a predetermined period. Although the executing subject of the processing illustrated in FIGS. 6A and 6B is the CPU 102 of the server 1, for convenience, explanation will be given assuming that the route generation unit 12, which is a functional component, is the subject. The same applies to the flow charts of FIG. 6B or later.

In OP 101, the route generation unit 12 determines whether or not a route search request has been received through the transmission/reception unit 11. When the route search request has been received (OP 101: YES), the processing proceeds to OP 102. When the route search request has not been received (OP 101: NO), the processing illustrated in FIG. 6A ends. Hereinafter, in FIGS. 6A and 6B and related flow charts, the user terminal 2 refers to a user terminal 2 that is the source of a route search request.

In OP 102, the route generation unit 12 searches routes according to search conditions received together with a route search request. In OP 102, for example, the route generation unit 12 extracts the service provider of a transportation that is in charge of an area including a departure place, an area including a destination, and a part or all of the area included between the departure place and the destination, and is designated or not designated as a search condition. The route generation unit 12 instructs, for example, the information acquisition unit 13 to acquire information corresponding to the period after the departure date and time or before the arrival date and time included in the search conditions, from the system 3 of the service provider of the extracted transportation.

when receiving an instruction from the route generation unit 12, the information acquisition unit 13 acquires information about the period after the departure date and time or before the arrival date and time included in the search conditions, from the system 3 designated by the route generation unit 12. Information acquired from the service provider of each transportation is, for example, timetables of the stations existing within the corresponding area, seat availabilities, and the like. The route generation unit 12 generates routes satisfying the search conditions, based on the information acquired by the information acquisition unit 13.

In OP 103, the route generation unit 12 transmits the generated multiple routes as search results to the user terminal 2 through the transmission/reception unit 11.

In OP 104, the route generation unit 12 determines whether or not information about a selected route has been received through the transmission/reception unit 11. When the information about the selected route has been received from the user terminal 2 (OP 104: YES), the processing proceeds to OP 105. When the information about the selected route has not been received from the user terminal 2 (OP 104: NO), the processing illustrated in FIG. 6A ends. It is determined that the information about the selected route has not been received from the user terminal 2, for example, if the information about the selected route has not been received even after the elapse of a predetermined time after the transmission of the search results or if session with the user terminal 2 is disconnected.

In OP 105, the route generation unit 12 outputs information about the selected route to the route storage unit 16 which then stores it. When, together with information about the selected route, a request for reserving route guidance is received, the route generation unit 12 sets a timer for the start time of the selected route.

In OP 106, the route generation unit 12 determines whether or not it is the start time of the selected route (in the case where route guidance is reserved) or whether or not a route guidance request for the selected route has been received from the user terminal 2 through the transmission/reception unit 11. When it is the start time of the selected route or when a route guidance request for the selected route is received (OP 106: YES), the processing proceeds to OP 107. When it is before the start time of the selected route and no route guidance request for the selected route has been received (OP 106: NO), the processing in OP 106 is repeated until the start time of the selected route or reception of the route guidance request. Note that when route guidance for the selected route is not reserved and no route guidance request has been received even after the start time of the selected route, the processing illustrated in FIG. 6A may end.

In OP 107, the route generation unit 12 instructs the route guidance unit 17 to start route guidance processing for the selected route. In OP 108, the route generation unit 12 executes rerouting determination processing. The details of rerouting determination processing will be described later. The rerouting determination processing determines whether or not the rerouting conditions are satisfied.

In OP 109, the route generation unit 12 determines whether or not the rerouting conditions are satisfied. When the rerouting conditions are satisfied (OP 109: YES), the processing proceeds to OP 121 illustrated in FIG. 6B. When the rerouting conditions are not satisfied (OP 109: NO), the processing proceeds to OP 110.

In OP 110, the route generation unit 12 determines whether or not the user terminal 2 has arrived at the destination of the selected route. Arrival to the destination of the selected route is determined by, for example, a notification from the route guidance unit 17. In OP 111, the route generation unit 12 instructs the route guidance unit 17 to end the route guidance processing. However, an instruction of the route guidance unit 17 to end the route guidance processing may be issued, for example, when receiving a route guidance notification from the user terminal 2 or when communication with the user terminal 2 is disconnected. The route generation unit 12 outputs, as an actual guidance result, information about the guided route for which guidance has ended to the route storage unit 16 which then stores it. Afterwards, the processing illustrated in FIG. 6A ends.

The processing illustrated in FIG. 6B is processing which is performed when rerouting conditions are satisfied. In OP 121, the route generation unit 12 transmits a message for making an inquiry about the necessity of rerouting to the user terminal 2.

In OP 122, the route generation unit 12 determines whether or not a response, which instructs to execute rerouting, to the inquiry about rerouting has been received from the user terminal 2 through the transmission/reception unit 11. When the response that instructs to execute rerouting has been received from the user terminal 2 (OP 122: YES), the processing proceeds to OP 123. When a response that instructs not to execute rerouting has been received from the user terminal 2 or no response has been obtained even after a lapse of a predetermined time (OP 122: NO), the processing illustrated in FIG. 6B ends.

In OP 123, the route generation unit 12 executes rerouting suggestion processing. The details of rerouting suggestion processing will be described later. Through rerouting suggestion processing, information about routes obtained by rerouting, information indicating, for each route, whether or not the user will be in time for a schedule, how long the user will be late, and the like are acquired.

In OP 124, the route generation unit 12 transmits information about the routes obtained by rerouting and the like to the user terminal 2 through the transmission/reception unit 11.

In OP 125, the route generation unit 12 determines, for the routes obtained by rerouting, whether or not information about a selected route has been received from the user terminal 2 through the transmission/reception unit 11. When, for the routes obtained by rerouting, information about the selected route has been received from the user terminal 2 (OP 125: YES), the processing proceeds to OP 127. For example, when, for the routes obtained by rerouting, no information about the selected route has been received from the user terminal 2 even after a lapse of a predetermined time (OP 125: NO), the processing proceeds to OP 126. In OP 126, the route generation unit 12 instructs the route guidance unit 17 to end the route guidance processing. Afterwards, the processing illustrated in FIG. 6B ends.

In OP 127, the route generation unit 12 outputs information about the selected route to the route storage unit 16 which then stores it.

In OP 128, the route generation unit 12 instructs the route guidance unit 17 to start route guidance processing for a newly selected route. This initiates route guidance processing for the newly selected route by the route guidance unit 17.

In OP 129, the route generation unit 12 determines whether or not the user will arrive at the location of the schedule before the start time through a travel along the newly selected route. When the destination of the newly selected route and the location of the schedule are different, the route generation unit 12 calculates a time taken to travel between both points from the distance between both points and the travel speed of the user and performs determination.

When it is determined that the user will arrive at the location of the schedule before the start time through a travel along the newly selected route (OP 129: YES), the processing proceeds to OP 108 illustrated in FIG. 6A. When it is determined that the user will not arrive at the location of the schedule before the start time through a travel along the newly selected route (OP 129: NO), the processing proceeds to OP 130.

In OP 130, the route generation unit 12 generates delay information and instructs the delay information distribution unit 15 to send a notification about the delay to the addresses of the participants of a schedule that is the purpose of the travel along the selected route. Accordingly, the participants of the schedule can be informed of the fact that the user of the user terminal 2 will be late for the schedule and how long the user will be late. Afterwards, the processing proceeds to OP 108 illustrated in FIG. 6A.

Note that the route generation unit 12's processing illustrated in FIGS. 6A and 6B is merely illustrative and is not necessarily the case.

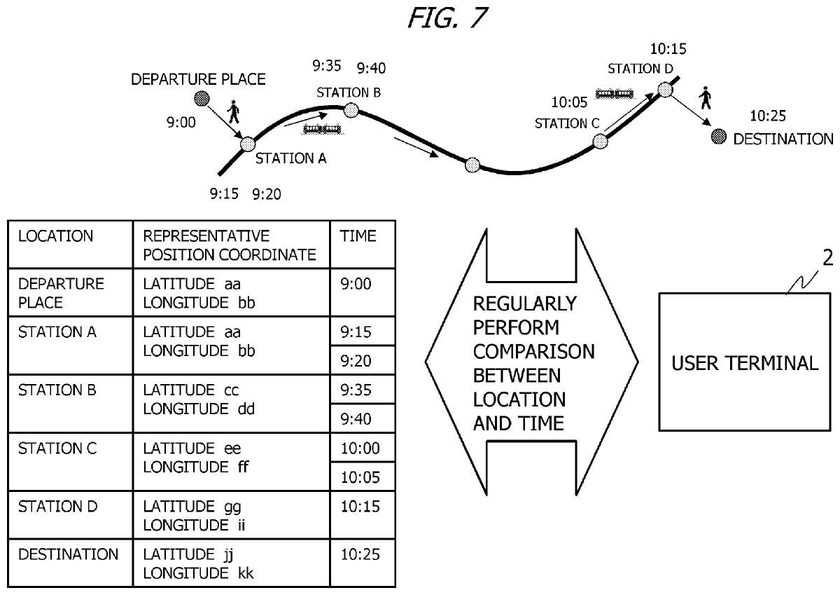

FIG. 7 is a diagram illustrating an example of rerouting determination processing. The rerouting determination processing is processing performed in the route generation unit 12 for determining whether or not the rerouting conditions are satisfied. Examples of rerouting conditions in the first embodiment include the situation where the user terminal 2 goes out of a guided route and the situation where a delay occurs in a public transport included in a guided route. In the first embodiment, the situation where the user terminal 2 goes out of a guided route is the situation where a delay in arriving at each via point in the guided route is expected. However, the definition of the situation where the user terminal 2 goes out of a guided route is not limited to this.

The route generation unit 12 acquires the representative position coordinates of the departure place, via points, and destination in the guided routes or selected route, for example, when route guidance processing starts or when information about the selected route is stored. In the example illustrated in FIG. 7, a station A, a station B, a station C, and a station D are via points.

The representative position coordinates of each point are set, for example, by a map production company, a company providing a traffic route search service, and the like in many cases. For example, a terminal station has multiple platforms each having a length of as long as several hundreds of meters. For this reason, in many cases, one representative position is set within the terminal station and the representative position coordinates of the terminal station are determined.

Next, the route generation unit 12 calculates, for each via point, the estimated time at which the user travels and passes through it. When a via point is a transfer station, the route generation unit 12 acquires, for the transfer station, the arrival time of the train and the departure time of the train to which the user transfers to. In the example illustrated in FIG. 7, an estimated arrival time (9:15) and a departure time (9:20) of a train at the station A, an arrival time (9:35) of the train and a departure time (9:40) of a train to which the user transfers to at the station B, an arrival time (10:00) of the train and a departure time (10:05) of a train to which the user transfers to at the station C, and a an arrival time (10:15) of the train at the station D.

when route guidance processing starts, the route generation unit 12 receives a set of location information and time information from the user terminal 2 in a predetermined period. The route generation unit 12 compares, for example, in a predetermined period, the latest location information and time information about the user terminal 2 with the representative position coordinates and the estimated arrival time or arrival time at each via point, thereby determining whether or not the user of the user terminal 2 is out of the guided route. Comparison of the latest location information and time information about the user terminal 2 with the representative position coordinates and the estimated arrival time or arrival time at each via point is performed every 20 seconds, for example.

For example, whether or not the user terminal 2 is out of the guided route is determined, for example, depending on whether or not the user terminal 2 will arrive at the next via point before the estimated arrival time. Whether or not the user terminal 2 will arrive at the next via point before the estimated arrival time can be determined based on, for example, a location relationship between the user terminal 2 and the next via point and the travel speed of the user terminal 2. A location relationship between the user terminal 2 and the next via point is, for example, acquired from location information about the user terminal 2 and the representative position coordinates of the via point. For example, when the means of transportation is walk, a walking speed acquired from walking history data is used as the travel speed of the user terminal 2. When walking history data related to the user of the user terminal 2 is not sufficiently stored, for example, a typical average speed is used depending on the user's attribute (for example, gender). The user's attribute is included, for example, in user information DB (not illustrated in the drawing). For example, when the means of transportation is a train, the travel speed of a train assumed to have uniform motion is used as the travel speed of the user terminal 2.

However, since errors in location information or time information may occur, an allowable range is provided for determination of whether the user terminal 2 will arrive at the next via point before the arrival time. For example, even if the predicted time at the next via point acquired from a set of location information and time information and a travel speed of the user terminal 2 is alpha seconds behind the estimated arrival time at the next via point, the route generation unit 12 does not determine that the user terminal 2 will arrive at the next via point after the arrival time.

In addition, for example, since when the next via point is a terminal station, there may be a difference between the representative position coordinates and the platform of the train that will be taken by the user, the allowable range may be set according to the size or the like of the via point.

In addition, the route generation unit 12 may, for example, monitor the travel speed of the user terminal 2 while performing the above-described determination processing and determining whether or not the user terminal 2 is out of the guided route depending on whether or not the user is successfully in a train.

In addition, the route generation unit 12 may, for example, acquire delay information about trains, buses, and the like or road traffic information via an API while performing the above-described determination processing, and determine their influence on the travel along the guided route. For example, in the example illustrated in FIG. 7, when delay information about the railway route of the train that will be taken by the user before the user arrives at the station A is acquired, the route generation unit 12 may determine that rerouting conditions are satisfied.

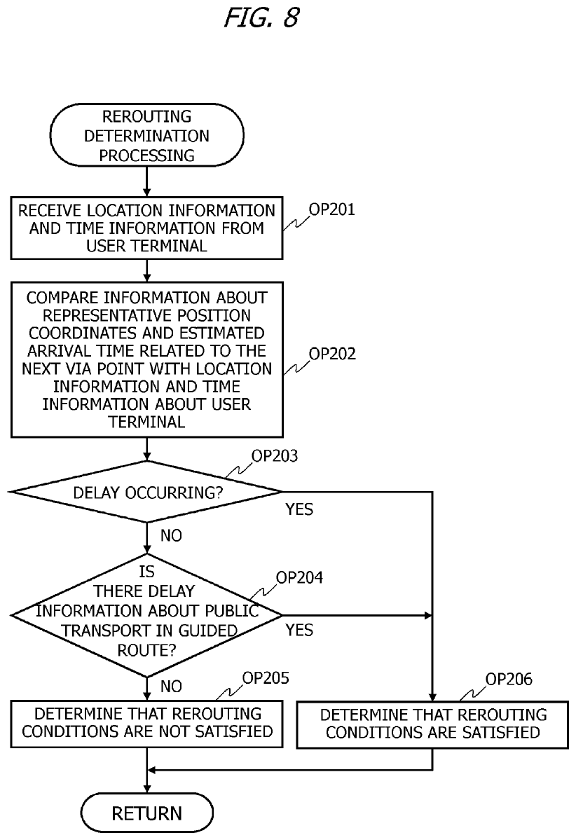

FIG. 8 is one example of a flow chart of rerouting determination processing in the route generation unit 12 of the server 1. The processing illustrated in FIG. 8 is processing executed in OP 108 illustrated in FIG. 6A.

In OP 201, the route generation unit 12 receives a set of location information and time information transmitted from the user terminal 2 in a predetermined period.

In OP 202, the route generation unit 12 compares information about the representative position coordinates and estimated arrival time related to the next via point with the location information and time information about the user terminal 2.

In OP 203, the route generation unit 12 determines whether or not the user terminal 2 will be in time at the next via point, that is, whether or not a delay is occurring. When it is determined that a delay is occurring (OP 203: YES), the processing proceeds to OP 206. In OP 206, the route generation unit 12 determines that rerouting conditions are satisfied. Afterwards, the processing proceeds to OP 109 illustrated in FIG. 6A. When it is determined that no delay is occurring (OP 203: NO), the processing proceeds to OP 204.

In OP 204, the route generation unit 12 determines whether or not there is delay information about a public transport included in the guided route. When there is delay information about a public transport included in the guided route (OP 204: YES), the processing proceeds to OP 206. In OP 206, the route generation unit 12 determines that rerouting conditions are satisfied. Afterwards, the processing illustrated in FIG. 8 ends, and the processing proceeds to OP 109 illustrated in FIG. 6A.

When there is no delay information about a public transport included in the guided route (OP 204: NO), the processing proceeds to OP 205. In OP 205, the route generation unit 12 determines that rerouting conditions are not satisfied. Afterwards, the processing illustrated in FIG. 8 ends, and the processing proceeds to OP 109 illustrated in FIG. 6A.

Note that the rerouting determination processing illustrated in FIG. 8 is merely illustrative and is not necessarily the case. For example, the processing in OP 204 is not necessarily executed depending on the embodiment.

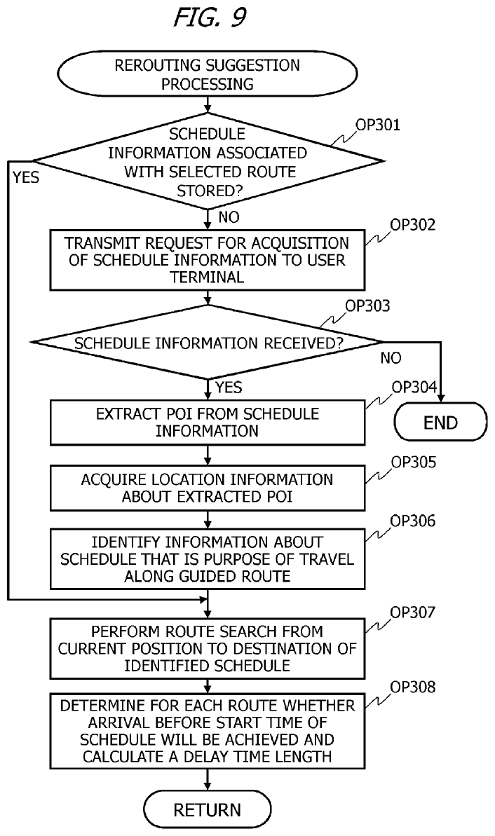

FIG. 9 is one example of a flow chart of rerouting suggestion processing in the route generation unit 12 of the server 1. The processing illustrated in FIG. 9 is processing executed in OP 123 illustrated in FIG. 6B.

In OP 301, the route generation unit 12 determines whether or not schedule information associated with the selected route (the current guided route) is stored, by making an inquiry of the route storage unit 16. When schedule information associated with the selected route (the current guided route) is stored (OP 301: YES), the processing proceeds to OP 307. When schedule information associated with the selected route (the current guided route) is not stored (OP 301: NO), the processing proceeds to OP 302.

OP 302 to OP 306 are processing performed when schedule information associated with the selected route (the current guided route) is not stored. In OP 302, the route generation unit 12 transmits a request for acquisition of schedule information to the user terminal 2.

In OP 303, the route generation unit 12 waits for reception of the schedule information from the user terminal 2. when the schedule information from the user terminal 2 is received (OP 303: YES), the processing proceeds to OP 304. For example, when the schedule information has not been received from the user terminal 2 even after a lapse of a predetermined time (OP 303: NO), the processing illustrated in FIG. 9 ends. When the processing illustrated in FIG. 9 ends, the processing illustrated in FIGS. 6A and 6B also ends.

In OP 304, the route generation unit 12 extracts a POI from the received schedule information. Note that the schedule information that has been received from the user terminal 2 in OP 303 may be all schedule information pieces stored in the user terminal 2, or information about a schedule expected to be started after the current date and time. When the schedule information that has been received from the user terminal 2 in OP 303 is all schedule information pieces stored in the user terminal 2, in OP 304, the route generation unit 12 extracts, from the received schedule information, information about schedules expected to be started after the current date and time, and extracts a POI from the extracted schedule information.

In OP 305, the route generation unit 12 acquires location information about the extracted POI. Location information about the POI is acquired, for example, from map information and the like. Map information may be held in the server 1, or map information held in an external server may be used through an API.

In OP 306, the route generation unit 12 identifies information about a schedule that is the purpose of a travel along the guided route, for example, based on location information about the extracted POI, location information about the destination of the guided route, location information about the user terminal 2, and the like. For example, the route generation unit 12 identifies schedule information including the POI corresponding to or closet to the destination of the guided route, as information about a schedule that is the purpose of a travel along the guided route.

In OP 307, the route generation unit 12 performs route search assuming that the location of schedule information that is the purpose of a travel along the guided route is the destination, and the current position of the user terminal 2 is the departure place (rerouting).

In OP 308, the route generation unit 12 determines, for each route obtained by rerouting in OP 307, whether or not the user will arrive before the start time of the schedule, and if the user will be late, calculates a delay time length. Afterwards, the processing illustrated in FIG. 9 ends, and the processing proceeds to OP 124 illustrated in FIG. 6B.

Note that the rerouting suggestion processing illustrated in FIG. 9 is processing performed when the destination of rerouting is the location of a schedule that is the purpose of a travel along the guided route. In the processing illustrated in FIG. 9, (A) processing for identification of the destination is the same processing as (C) processing for identification of a schedule that is the purpose of a travel along the guided route, and corresponds to the processing from OP 302 to OP 306. In the example illustrated in FIG. 9, (B) search for a route as an alternative to a guided route (rerouting) corresponds to the processing of OP 307. In the example illustrated in FIG. 9, (D) determination of whether or not a travel along the route obtained by rerouting allows the user to be in time for the identified schedule corresponds to the processing of OP 308.

Note that rerouting suggestion processing is not limited to the processing illustrated in FIG. 9. When the destination of the guided route is used as the destination of rerouting, for example, the processing from OP 301 to OP 306 is not performed, and in OP 307, route search is performed assuming that the destination is the destination of the guided route.

<Example of Display Screen of User Terminal>

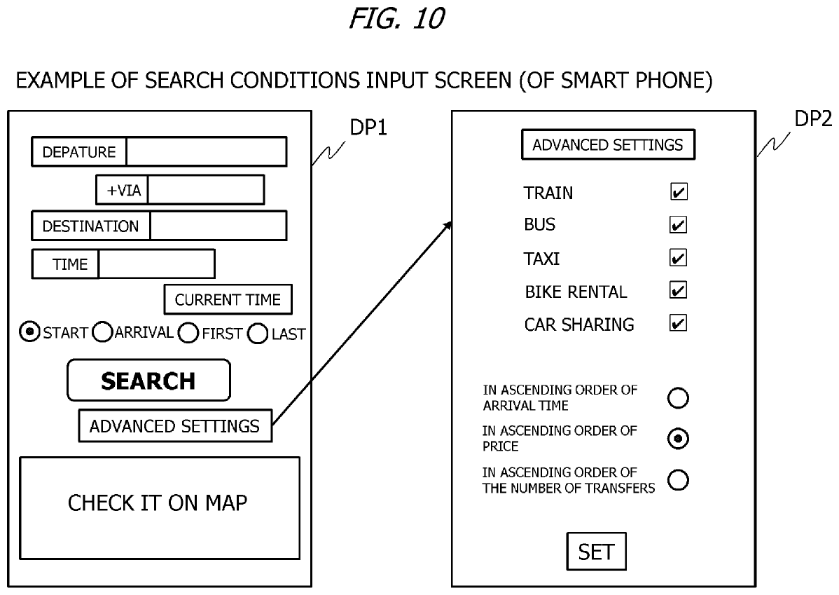

Exemplary transition of the screen on the user terminal 2 from route search to occurrence of rerouting to guidance of routes obtained by rerouting will now be described with reference to FIGS. 10 to 14. In explanation related to FIGS. 10 to 14, the user terminal 2 is supposed to be a smartphone.

FIG. 10 is a diagram illustrating an example of search conditions input screen of the user terminal 2. The search conditions input screen DP1 is, for example, a screen displayed when a multimodal traffic application program is activated.

The search conditions input screen DP1 includes input fields of a departure place, destination, via point, and date and time. Among these, for example, a departure place and destination are essential input items. For example, a via point and date and time are optional input items.

In addition, radio buttons (departure, arrival, first train, and last train) for designating a time related to a route to be searched for are displayed below the date and time input field. Selecting the “departure” radio button designates the date and time input in the date and time input field as the departure date and time. Selecting the “arrival” radio button designates the date and time input in the date and time input field as the arrival date and time. Selecting the “first” radio button designates route search using the first train. Selecting the “last” radio button designates route search using the last train. Note that when there is no entry to the date and time input field, route search is performed although a reservation is not made on any transportation since the train, flight, or the like of the transportation is not identified.

Selecting the advanced settings button displays an advanced settings screen DP2. The advanced settings screen DP2 includes check boxes for selecting transportations to be search targets, and radio buttons for designating sorting conditions used when routes according to the research results are displayed. On the advanced settings screen DP2 illustrated in FIG. 10, the options of search target transportation include train, bus, taxi, bicycle-sharing system, and car sharing. Transportations with their check boxes checked are search targets.

The advanced settings screen DP2 illustrated in FIG. 10 includes, as search results sorting conditions, in ascending order of arrival time, in ascending order of price, and in ascending order of the number of transfers. In, among these, the condition with its radio button selected, the search results are sorted. For example, selecting the “SET” button on the advanced settings screen DP2 displays the search conditions input screen DP1.

Selecting the “search” button on the search conditions input screen DP1 is one example of an operation of inputting a route search request on the user terminal 2. Selecting the “search” button on the search conditions input screen DP1 causes the route search management unit 21 of the user terminal 2 to transmit a route search request to the server 1. Search conditions are generated based on the route search request and information input on the search conditions input screen DP1 and the advanced settings screen DP2, and transmitted to the server 1. When the route search request from the user terminal 2 is received, the server 1 performs route search (see FIG. 6A, OPs 101 to 102). Note that the screen configurations of the search conditions input screen DP1 and the advanced settings screen DP2 illustrated in FIG. 10 are merely illustrative and not necessarily the cases.

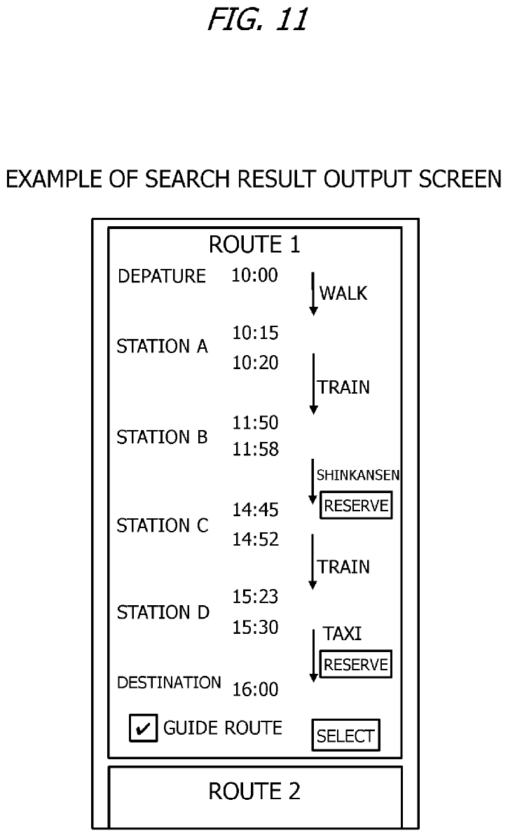

FIG. 11 is one example of search result output screen on the user terminal 2. A search result output screen is, for example, a screen displaying information about routes as search results received from the server 1. On the search result output screen, for example, routes are displayed in an order according to sorting conditions designated on the advanced settings screen DP2 illustrated in FIG. 10. In FIG. 11, all information is not contained on one page and scrolling it displays information about Route 2 or later.

On the search result output screen illustrated in FIG. 11, for information about each route, a “GUIDE ROUTE” check button and a “SELECT” button are set. Selecting the “SELECT” button is one example of an operation of selecting a selected route on the user terminal 2. Further, when the “SELECT” button is selected, the user terminal 2 transmits information about the selected route to the server 1. When the “GUIDE ROUTE” check button is checked, together with information about the selected route, a request for reserving route guidance for the selected route is transmitted. When the request for reserving route guidance for the selected route is received together with information about the selected route, the server 1 starts route guidance processing for the selected route at the start time of the selected route (OP 106: YES and OP 107 in FIG. 6A).

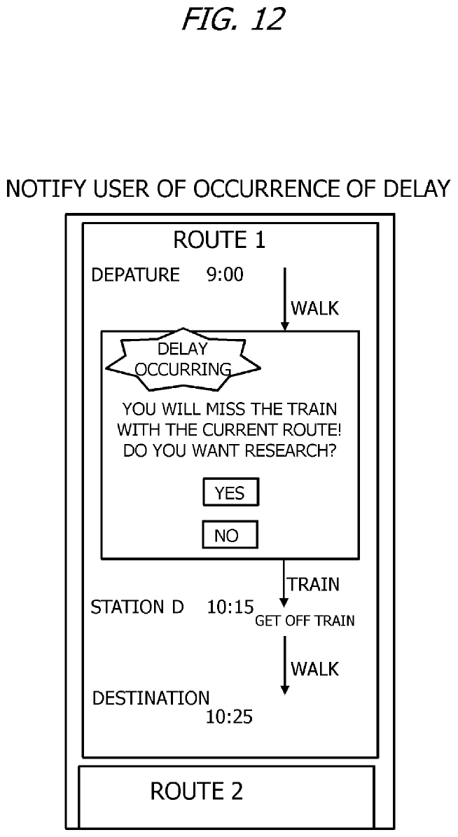

FIG. 12 is one example of rerouting inquiry screen on the user terminal 2. A rerouting inquiry screen is a screen for making an inquiry of the user of the user terminal 2 to allow rerouting or not. A rerouting inquiry screen is displayed on the user terminal 2, for example, during route guidance processing and when the server 1 determines that the rerouting conditions are satisfied (OP 108 and OP 109: YES in FIG. 6A) and a message for making an inquiry about rerouting is received from the server 1 (OP 121 in FIG. 6B).

In the example illustrated in FIG. 12, on the screen of the user terminal 2 during route guidance, information about the guided route is displayed and a message of an inquiry about rerouting is displayed in a popup window. In the example illustrated in FIG. 12, within a message of an inquiry about rerouting, the message that a delay is occurring with the guided route, a message asking for execution of rerouting, a YES button, and a NO button are displayed. For example, selecting the YES button causes the route search management unit 21 of the user terminal 2 to transmit a response that instructs the server 1 to execute rerouting. When the response that instructs to execute rerouting is received (OP 122: YES in FIG. 6B), the server 1 starts rerouting suggestion processing (OP 123 in FIG. 6B).

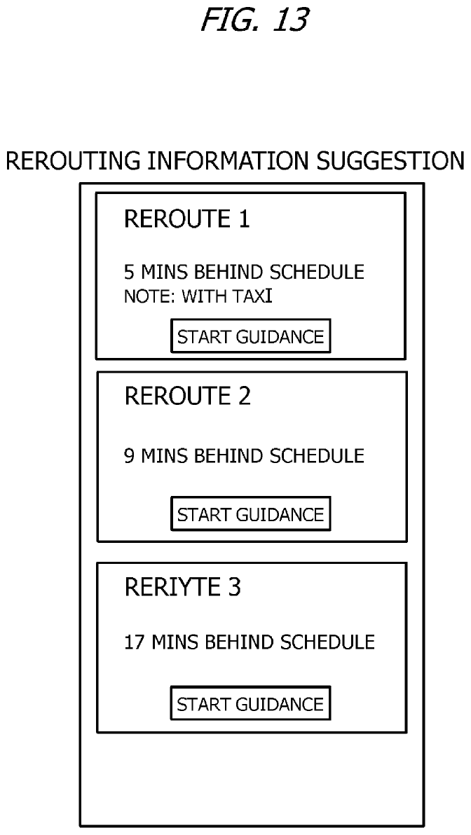

FIG. 13 is one example of rerouting information suggesting screen on the user terminal 2. A rerouting information suggesting screen is, for example, a screen displaying information about routes obtained by rerouting received from the server 1. On the rerouting information suggesting screen illustrated in FIG. 13, for example, information about the routes obtained by rerouting are displayed in an ascending order of late time. Note that the same information as the information displayed for the routes on the search result output screen illustrated in FIG. 11 may be displayed for the routes on the rerouting information suggesting screen illustrated in FIG. 13. Alternatively, selecting any of the routes on the rerouting information suggesting screen illustrated in FIG. 13 may display a screen displaying the same information as the route information displayed on the search result output screen illustrated in FIG. 11.

On the rerouting information suggesting screen illustrated in FIG. 13, for example, a guidance start button is set for information about each route obtained by rerouting. When the user selects a guidance start button, the user terminal 2 determines the route with that guidance start button set as a newly selected route and transmits the information about the selected route and a route guidance request to the server 1. When new information about the selected route and the route guidance request are received (OP 125: YES in FIG. 6B), the server 1 starts route guidance processing for the newly selected route (OP 128 in FIG. 6B).

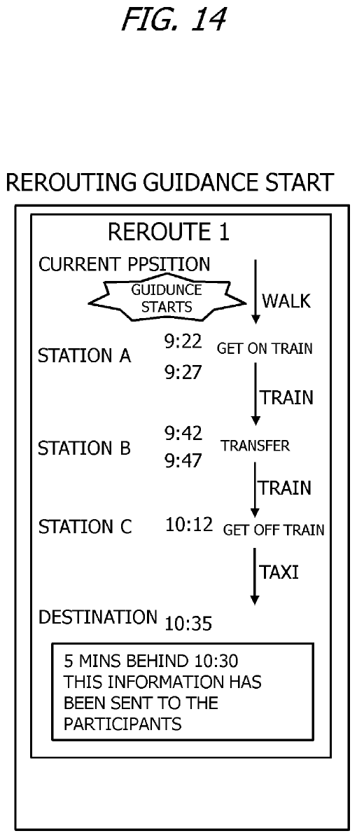

FIG. 14 is one example of rerouting guidance start screen on the user terminal 2. A rerouting guidance start screen is a screen received from the server 1 when the server 1 starts route guidance processing for the route obtained by rerouting, and displayed on the user terminal 2.

On the rerouting guidance start screen, for example, the departure times and/or arrival times at the departure place, via points, and destination and a means of transportation used between the via points are displayed as information about the guided route for which guidance is currently performed. In the case where the user will not be in time for the next schedule through a travel along the guided route (OP 129: NO in FIG. 6B), the message that delay information has been sent to the participants of the schedule is displayed on the rerouting guidance start screen (OP 130 in FIG. 6B). In the example illustrated in FIG. 14, the message that delay information has been sent to the participants of the schedule includes the start time of the schedule, a delay time length, and the fact that the information has been sent to the participants.

### Effects of the First Embodiment

In the first embodiment, when a delay with a guided route for the user terminal 2 during route guidance processing is detected, the server 1 performs rerouting and determines whether or not the user travelling along the route obtained by rerouting will be in time for a schedule that is the purpose of the travel along the guided route. On the user terminal 2, routes obtained by rerouting and whether or not the user will be in time for a schedule for each route are displayed (see FIG. 13 and other drawings). Accordingly, information about the influences of travels along routes obtained by rerouting on the schedule can be suggested to the user of the user terminal 2. The user of the user terminal 2 can select a route to be newly used, based on the information about these influences on the schedule.

In addition, in the first embodiment, when it is determined that the user travelling along the route obtained by rerouting will be late for a schedule that is the purpose of the travel along the guided route, the server 1 calculates how long the user will be late, i.e., a delay time length and transmits it to the user terminal 2. On the user terminal 2, routes obtained by rerouting and a delay time length when the use is not in time for a schedule for each route are displayed (see FIG. 13 and other drawings). Accordingly, the user of the user terminal 2 can recognize, from the delay time length, the level of an influence on the schedule.

In addition, in the first embodiment, in the case where the user will not be in time for a schedule through a selected route newly selected among the routes obtained by rerouting, the server 1 notifies delay information to the addresses of the participants of the schedule. Accordingly, the participants of the schedule can be automatically notified of the fact that the user of the user terminal 2 will be late, thereby saving work in the user terminal 2. Further, the participants of the schedule can be informed of the delay of the user of the user terminal 2 more earlier and can, for example, do other things they have to do while they are waiting for the arrive of the user of the user terminal 2 or take countermeasures such as delaying the start time.

In addition, in the first embodiment, in the case where the server 1 has not received schedule information, which is associated with the selected route, in advance from the user terminal 2, the server 1 acquires schedule information from the user terminal 2 and identifies the schedule information that is the purpose of the travel along the selected route. Accordingly, the schedule that is the purpose of the travel along the route under guidance is identified even if the user of the user terminal 2 does not, for example, carry out an operation of identifying the schedule that is the purpose of the travel along the route, and the user of the user terminal 2 can receive information about an influence on the schedule related to the travel along the route obtained by rerouting.

<Variation>

In the first embodiment, in the case where schedule information associated with a guided route is not stored in the server 1, the server 1 acquires schedule information from the user terminal 2 and performs processing for identification of a schedule that is the purpose of a travel along the guided route ((C) processing for identification of a schedule that is the purpose of a travel along the guided route, in rerouting suggestion processing). Alternatively, the user terminal 2 may perform processing for identification of a schedule that is the purpose of a travel along the guided route.

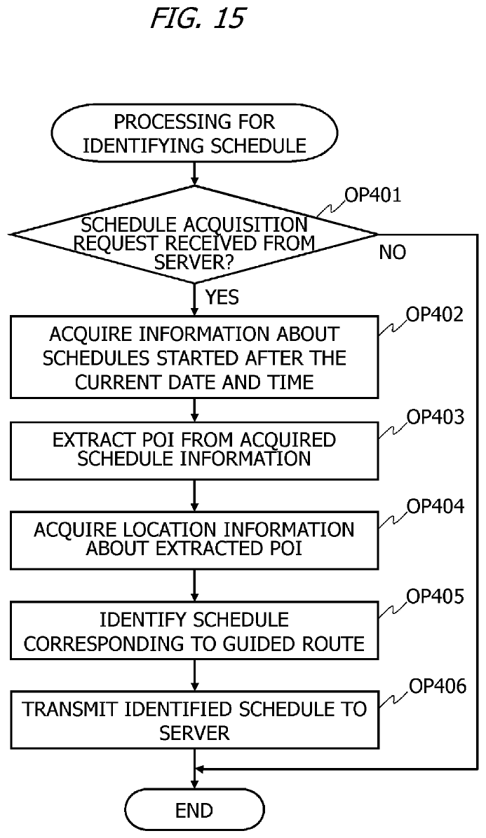

FIG. 15 is one example of a flow chart of schedule identifying processing in the user terminal 2. Schedule identifying processing is processing for identifying a schedule that is the purpose of a travel along the guided route. The processing illustrated in FIG. 15 is, for example, repeated in a predetermined period. Although the executing subject of the processing illustrated in FIG. 15 is the CPU 201 of the user terminal 2, for convenience, explanation will be given assuming that the route search management unit 21, which is a functional component, is the subject.

In OP 401, the route search management unit 21 determines whether or not a schedule acquisition request has been received from the server 1. Note that a schedule acquisition request in the variation is a request for acquisition of schedule information about a schedule that is the purpose of a travel along the guided route. When the schedule information request from the server 1 is received (OP 401: YES), the processing proceeds to OP 402. When the schedule acquisition request has not been received from the server 1 (OP 401: NO), the processing illustrated in FIG. 15 ends.

In OP 402, the route search management unit 21 acquires information about schedules expected to be started after the current date and time, from the schedule management unit 22. In OP 403, the route search management unit 21 extracts a POI from the acquired schedule information. In OP 404, the route search management unit 21 acquires location information about the extracted POI. Location information about the POI is acquired, for example, from map information held in an external server.

In OP 405, the route search management unit 21 identifies information about a schedule that is the purpose of a travel along the guided route, for example, based on location information about the extracted POI, location information about the destination of the guided route, location information about the user terminal 2, and the like. For example, schedule information including the POI corresponding to or closet to the destination of the guided route is identified as information about a schedule that is the purpose of a travel along the guided route. Information about a guided route may be, for example, received from the server 1 when route guidance processing starts, or may be stored in the user terminal 2 when it is selected as a selected route.

In OP 406, the route search management unit 21 transmits the identified schedule information to the server 1. The server 1 receives schedule information about the schedule that is the purpose of a travel along the guided route from the user terminal 2, and determines whether or not the user will be in time for the schedule through each route obtained by rerouting and how long the user will be late.

Note that in the case where the user terminal 2 executes the processing illustrated in FIG. 15, the route generation unit 12 of the server 1 executes the processing of OPs 301 to 303, OP 307, and OP 308 and does not execute the processing of OPs 304 to 306, for example, in the rerouting suggestion processing illustrated in FIG. 9.

In the case where the user terminal 2 identifies a schedule that is the purpose of a travel along the guided route, the processing load on the server 1 can be decreased.

<Others>

The user terminal 2 may have the same functions as those of the server 1 in the first embodiment so that the user terminal 2 may perform the same processing as that performed by the server 1 in the first embodiment. In addition, although the explanation in the first embodiment and the variation has been made assuming that a multimodal traffic search system is used, the application of the techniques explained in the first embodiment and the variation is not limited to a multimodal traffic search system. The techniques explained in the first embodiment and the variation is also applicable to, for example, a car navigation system, a route search system using a single means of transportation, or the like.

In the first embodiment and the variation, in the case where schedule information associated with a guided route is not stored in the server 1, schedule information about a schedule that is the purpose of a travel along the guided route is identified from the schedule information stored in the user terminal 2. Alternatively, in the case where schedule information associated with a guided route is not stored in the server 1, for example, an inquiry about schedule information about a schedule that is the purpose of a travel along the guided route may be made of the user of the user terminal 2 through a massage displayed on the user terminal 2.

In the case where, for example, a route search request is input from the schedule management unit 22 to the route search management unit 21, the user terminal 2 may store an association between a selected route that has been selected among the results of route search and schedule information that has caused generation of the route search request. In this case, when receiving a request for acquisition of schedule information from the server 1, the user terminal 2 transmits schedule information associated with a route corresponding to a route designated by this acquisition request to the server 1.

<Recording Medium>

A program that causes a computer or another machine or device (hereinafter, a computer or the like) to implement the processing by the center server 10, the edge server 20, the fixed camera 30, or the vehicle 40 described above can be recorded in a computer-or the like-readable recording medium. By causing a computer or the like to read and execute the program in the recording medium, the computer functions as the center server 10, the edge server 20, the fixed camera 30, or the vehicle 40 described above.

Here, the recording medium that can be read by the computer or the like refers to a non-transitory recording medium that can store information such as data and/or programs by means of electrical, magnetic, optical, mechanical or chemical action and can be read from the computer or the like. From among such recording mediums, ones that can be removed from the computer or the like include, for example, a flexible disk, a magnetooptical disk, a CD-ROM, a CD-R/W, DVD, a Blu-ray disk, a DAT, an 8 mm tape and a memory card such as a flash memory. Also, recording mediums fixed to the computer or the like include, e.g., a hard disk and a ROM (read-only memory). Furthermore, an SSD (solid state drive) can be used as either a recording medium that can be removed from the computer or the like or a recording medium fixed to the computer or the like.

What is claimed is:

1. An information processing apparatus comprising:
a controller configured to:
start guidance processing for a first route in response to a route guidance request,
search for one or more second routes as alternative to the first route when it is determined that a user terminal that is a source of the route guidance request will be delayed from the first route,
acquire at least a start time of a first schedule that is a purpose of a travel along the first route and a first location associated with the first schedule,
determine whether or not arrival at the first location before the start time will be achieved through a travel along each of the one or more second routes, and
output information about each of the one or more second routes and information about whether or not arrival at the first location before the start time will be achieved through a travel along each of the one or more second routes.

2. The information processing apparatus according to claim 1, wherein
when it is determined that arrival at the first location before the start time will not be achieved through a travel along each of the one or more second route, the controller is configured to calculates a time length delayed from the start time, and output the time length delayed from the start time together with information about each of the one or more second route.

3. The information processing apparatus according to claim 1, wherein the controller is configured to:
further acquire information about an address of a participant of the first schedule, and
when it is determined that arrival at the first location before the start time will not be achieved through a travel along a route selected as a guidance target among the one or more second routes, send a notification that the user of the user terminal will be late, to the address.

4. The information processing apparatus according to claim 1, wherein the controller is configured to:
acquire information about a schedule set in the user terminal,
extract a noun related to a location from the acquired information about the schedule,
acquire location information corresponding to the extracted noun, and
identify the first schedule based on a comparison between location information about the user terminal and the location information corresponding to the extracted noun.

5. An information processing method comprising:
starting guidance processing for a first route in response to a route guidance request;
searching one or more second routes as alternative to the first route when it is determined that a user terminal that is a source of the route guidance request will be delayed from the first route;
acquiring at least a start time of a first schedule that is a purpose of a travel along the first route and a first location associated with the first schedule;
determining whether or not arrival at the first location before the start time will be achieved through a travel along each of the one or more second routes; and
outputting information about each of the one or more second routes and information about whether or not arrival at the first location before the start time will be achieved through a travel along each of the one or more second routes.

6. An information processing system comprising:
one or more controllers configured to:
start guidance processing for a first route in response to a route guidance request,
search for one or more second routes as alternative to the first route when it is detected that a user terminal that is a source of the route guidance request will be delayed from the first route,
acquire at least a start time of a first schedule that is a purpose of a travel along the first route and a first location associated with the first schedule,
determine whether or not arrival at the first location before the start time will be achieved through a travel along each of the one or more second routes, and
output information about each of the one or more second routes and information about whether or not arrival at the first location before the start time will be achieved through a travel along each of the one or more second routes.
